(19) United States
(12) Patent Application Publication
(10) Pub. No.: US 2009/0218267 A1
(43) Pub. Date: Sep. 3, 2009

(54) SEPARATION COLUMN AND LIQUID CHROMATOGRAPH

(75) Inventors: Kiyotoshi MORI, Hitachinaka (JP); Hironori Kaji, Hitachinaka (JP); Masahito Ito, Hitachinaka (JP); Kimihiko Ishii, Hitachinaka (JP); Tomohiro Shoji, Hitachinaka (JP); Kousaku Toyosaki, Ishioka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi-Technologies Corporation

(21) Appl. No.: 12/392,117

(22) Filed: Feb. 25, 2009

(30) Foreign Application Priority Data
Feb. 28, 2008 (JP) 2008-048350

(51) Int. Cl. B01D 15/10

(52) U.S. Cl. 210/198.2

(57) ABSTRACT

The present invention provides a separation column including a monolithic rod without a resin coating material. The separation column can prevent the monolithic rod from destroying, and a liquid can be delivered at a high pressure into the separation column. The separation column includes the monolithic rod (monolithic silica rod) in a tapered-columnar shape, and a clad with the interior formed in a tapered-columnar shape. The monolithic rod is built into the clad.

### CLAIM OF PRIORITY

The present application claims priority from Japanese Patent Application JP 2008-048350 filed on Feb. 28, 2008, the content of which is hereby incorporated by reference into this application.

### FIELD OF THE INVENTION

The present invention relates to a separation column and a liquid chromatograph. For example, the present invention relates to a separation column that is used for a high performance liquid chromatograph or the like and separates components in a liquid sample, and a liquid chromatograph that equips the separation column, particularly suitable for high-speed analysis.

### BACKGROUND OF THE INVENTION

In a conventional high performance liquid chromatograph, shortening of analysis time with a general particle-filled column requires an increase of the amount of liquid delivery per unit time, and also requires a decrease of the diameters of the filled particles and an increase the surface areas of the particles in order to maintain the same separation performance as before. That is, whereas a conventional column is formed by filling a cylindrical container having an inner diameter of about 4 mm with particles of about 5 μm in diameter, it is possible to shorten analysis time to one-tenth by changing the particle diameter to about 2 μm.

The decrease of the particle diameter increases flow resistance, however, and a liquid delivery at a high pressure is required. This causes a problem that an analyzer should be resistant to a high pressure.

In order to solve the problem, a monolithic column, which is different from a particle-filled column and formed by integrating a three-dimensional network skeleton and voids (flow paths, macro-pores, and through-pores), can be used to increase the surface area and porosity and prevent the flow resistance from increasing. For example, a monolithic silica column having a porous solid (a monolithic rod or a monolithic silica rod) in a narrow tube is used to improve the performance.

In the case of a porous monolithic rod, however, when a liquid is delivered at a high pressure, the monolithic rod is misaligned in the direction of the flow in a clad due to a difference in pressure between the liquid inlet and the liquid outlet, the tip of the monolithic rod being destroyed. In order to solve the above problem, a technique that a resin coating material is applied on the outer circumferential surface of a porous monolithic rod is known and described in JP-A-H11-64314, for example.

Unfortunately, if a resin coating material is applied on the outer circumferential surface of a porous monolithic rod, a liquid flowing into a separation column may meet the resin, a volatile solvent in the resin may elute during analysis with the separation column, and the separation performance may deteriorate. For this reason, it is desirable not to use a resin coating material.

An object of the present invention is to make it possible to deliver a liquid at a high pressure in a separation column that, including a porous monolithic rod, does not include a resin coating material.

### SUMMARY OF THE INVENTION

A porous monolithic rod of the present invention is formed in a tapered-columnar shape and receives a pressing force in the axial direction caused by a fluid on the tapered surface of the monolithic rod, enhancing a pressure resistance of the monolithic rod.

According to the present invention, a monolithic rod, without a resin coating material, is not misaligned in the direction of the flow and can deliver a liquid at a high pressure. As a result, it is possible to avoid a breakdown of the monolithic rod and an elution of a volatile solvent from a resin coating material.

### BRIEF DESCRIPTION OF THE DRAWINGS

FIG. 1 is a cross-sectional view of a separation column in accordance with an embodiment of the present invention;

FIG. 2 is a block diagram of a liquid chromatograph in accordance with an embodiment of the present invention;

FIG. 3 is a block diagram of a liquid chromatograph including connected separation columns in accordance with another embodiment of the present invention; and

FIG. 4 is a cross-sectional view of a separation column in accordance with another embodiment of the present invention.

### DETAILED DESCRIPTION OF THE PREFERRED EMBODIMENTS

Embodiments of the present invention will now be described with reference to drawings.

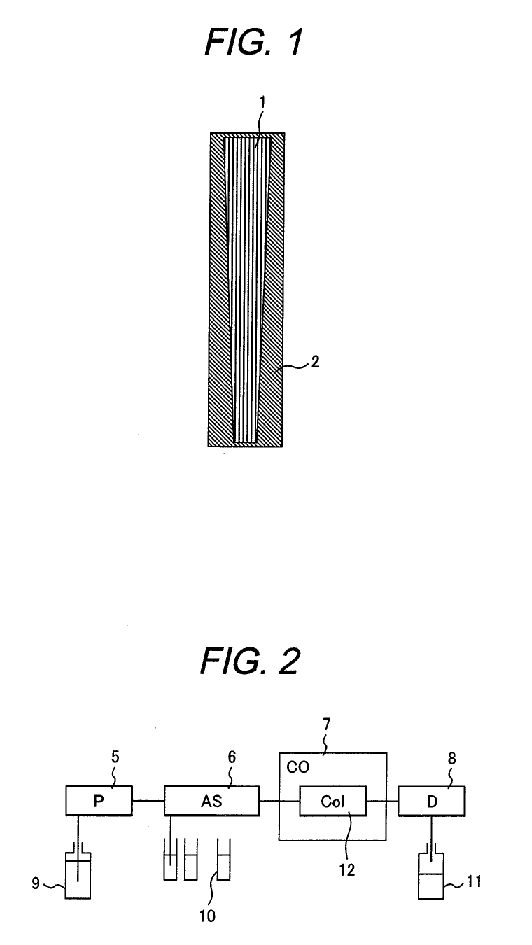

FIG. 1 shows a separation column in accordance with an embodiment of the present invention. A tapered-columnar monolithic rod 1 can be placed in a clad 2 having a tapered bore in the interior as shown in FIG. 1. The bore of the clad 2 has a tapered-columnar shape for the monolithic rod 1.

The clad 2 is composed of a material, such as stainless steel, PEEK (polyetheretherketone), VESPEL (registered trademark of DuPont), titanium, or fluororesin.

The tapered-columnar internal shape of the clad 2 can prevent the monolithic rod 1 from being misaligned in the direction of the flow in the clad 2. As a result, a liquid can be delivered to the tapered-columnar monolithic rod 1 at a higher pressure up to the mechanical strength of the monolithic rod 1 than to a monolithic rod with a columnar shape.

The diameter of the monolithic rod 1 is calculated by Equation 1 and the length of the monolithic rod 1 in the flow direction, namely the length of the separation column, is calculated by Equation 2 in a liquid chromatograph in which the linear velocity is increased in order to shorten analysis time, that is, a high pressure, particularly, the maximum pressure of 5 to 60 MPa is applied.

$$\begin{matrix}u = \frac{F}{{π ( \frac{D}{2} )}^{2} ɛ} & Equation 1 \\ H = \frac{L}{N} & Equation 2\end{matrix}$$

In Equation 1, u denotes a linear velocity, F denotes a flow rate of a mobile phase, D denotes the diameter of the monolithic rod 1, and e denotes the porosity of the monolithic rod 1.

The porosity of the monolithic rod 1 is in the range of about 0.6 to 0.8. If the linear velocity u is a constant of 10 mm/s and the flow rate F is in the range of 0.5 to 2.0 mL/min, which is the range of a half to two times of 1.0 mL/min that is a value adopted in a general liquid chromatograph, the diameter of the monolithic rod 1 is in the range of 1.2 to 2.8 mm. Preferably, the diameter of the monolithic rod 1 is 2 mm or less.

In Equation 2, H denotes a height equivalent to a theoretical plate, L denotes the length of a column, and N denotes a number of theoretical plates. If the height equivalent to a theoretical plate H is 10 μm and the number of theoretical plates N is 10,000 as in the case of an ordinary separation column, the length of the column L is 100 mm. The length of the column L varies with a sample to be separated and analysis time, preferably, in the range of 30 to 200 mm.

When a liquid is delivered at an identical pressure, the amount of the liquid delivered per unit time, namely the consumption of the mobile phase, is inversely proportional to the sectional area through which the liquid flows, namely the sectional area of the monolithic rod if the porosity is constant. Consequently, the monolithic rod having a diameter of 2 mm or less according to the present invention can reduce the consumption of the mobile phase to a quarter compared to a conventional monolithic rod having a diameter of about 4 mm.

In a practical use, the present invention provides a useful column that can be used in a flow rate region of 1.0 ml/min or less, which is widely adopted in a general high performance liquid chromatograph.

With reference to FIG. 2, a liquid chromatograph including the separation column in accordance with the embodiment of the present invention will now be described. The liquid chromatograph includes an eluent 9, a liquid delivery pump (a liquid delivery means) 5, an automatic sampler (a liquid sample supply means) 6, a column oven 7, a separation column 12, a detector 8, and a waste liquid container 1. The liquid delivery pump 5 aspirates the eluent 9 through piping.

The eluent 9 is discharged from the liquid delivery pump 5, supplied to the automatic sampler 6, where a sample 10 subjected to component analysis is injected to the eluent 9 through an injection port. The sample 10 is mixed with the eluent 9 and sent to the separation column 12 installed in the column oven 7. The sample 10 is separated into the components to be inspected in the separation column 12 and flows into the detector 8 through piping.

The detector 8 includes a light source, a flow cell, and an optical sensor, which are not shown in FIG. 2. The detector 8 analyzes the components included in the sample 10. After the detection is completed in the detector 8, the sample 10 is discharged to the waste liquid container 11 through piping and retrieved.

By using the aforementioned separation column for a liquid chromatograph, the liquid chromatograph can increase the liquid flow rate and shorten the analysis time without an increase in the solvent consumption.

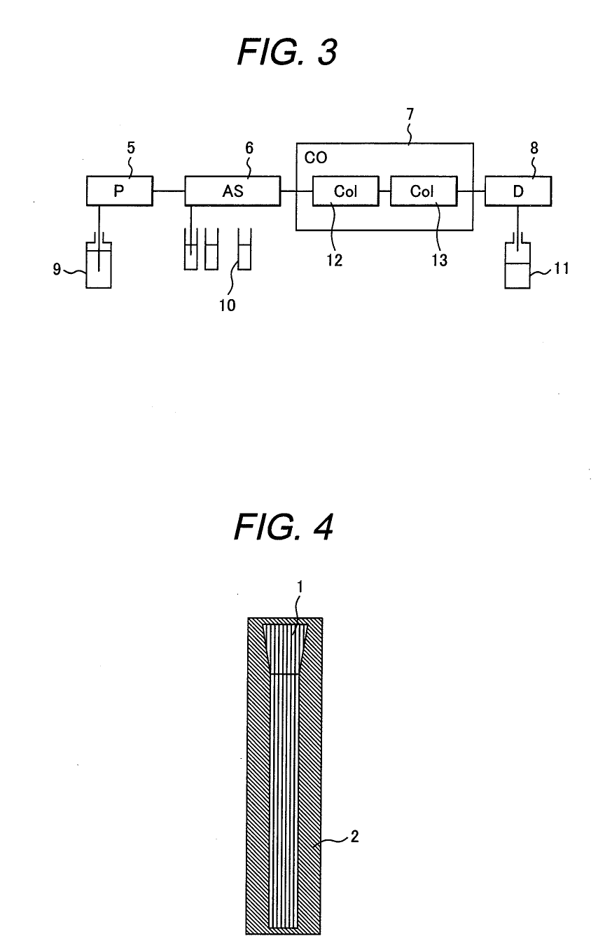

With reference to FIG. 3, another embodiment will now be described.

The liquid chromatograph can include plural separation columns 12 and 13 which are the separation columns according to the aforementioned embodiment of the present invention and connected each other (the number of the separation columns may be more than two, although it is two in this embodiment). By connecting plural separation columns 12 and 13, the whole length of the separation columns is substantially increased and the components of a sample is analyzed with higher separation performance than the case of a single separation column.

Each of the connected plural separation columns can share the back pressure, reducing the back pressure per one separation column. As a result, the back pressure is lower than that of a single separation column having the same length as the connected separation columns, increasing the linear velocity and shortening the analysis time.

Preferable embodiments are further explained hereunder.

A monolithic rod with a length of 75 mm has a tapered shape along the flow of a liquid, the diameter of the inlet port for the liquid being 2.3 mm and the diameter of the outlet port being 2.2 mm. The monolithic rod is preferably covered with a heat-shrinkable tube in order to improve chemical resistance at a wetted part. As an example, the tube is composed of FEP (Fluorinated Ethylene Propylene) and has a wall thickness of 0.2 mm.

Other examples of fluororesin materials covering the monolithic rod include PTFE (Polytetrafluoroethylene), PFA (Perfluoroalkoxy), and ETFE (Ethylene Tetrafluoroethylene). The tube should be equipped with an outer casing (clad) composed of any material on the exterior for pressure resistance.

Examples of material for the clad include a stainless steel such as SUS316, plastics such as PEEK (Polyetheretherketone), a low-melting-point metal, and a low-melting-point glass. A highly flexible layer composed of silicon rubber or silica bead, for example, can be disposed between the silica rod and the outer casing. If the monolithic rod is covered with the fluorores in material, the highly flexible layer can be disposed between the fluororesin cover and the outer casing.

When a mobile phase is delivered to the monolithic column at a flow rate of about 1 ml/min, a hydrostatic pressure of about 20 MPa is applied to the inlet port of the monolithic rod, depending on the viscosity and the temperature of the mobile phase. As the mobile phase flows in the porous monolithic rod, the hydrostatic pressure lowers almost linearly along the axial direction and becomes almost 5 MPa at the outlet port. The monolithic rod undergoes a force toward the outlet port due to the flow of the mobile phase.

The monolithic rod does not move due to static friction force generated at the interface with the outer cover or the outer casing of the clad. If the force to move a monolithic rod (moving force) exceeds a maximum static friction force, however, the monolithic rod is moved and pressed on a part of the outlet port, such as the frit surface at the outlet port.

In this case, the monolithic rod is pressed on the frit surface by a differential force calculated by subtracting the maximum static friction force from the moving force. Consequently, the monolithic rod undergoes the compression stress calculated by dividing the differential force by the area of the frit surface. When the compression stress exceeds a critical stress of several MPa, the monolithic rod is destroyed by the compression stress.

The monolithic rod in the tapered shape can solve the problem. In this case, the moving force should be divided into a component parallel to the tapered surface and a component vertical to the tapered surface. The parallel component of the force balances with the friction force. The vertical component balances with the reactive force from the outer casing.

An effect of the tapered shape is that when the tapered surface of the monolithic rod has a slope of about 10 degrees as an extreme case, the parallel component of the moving force is equal to the moving force multiplied by cos 10°, nearly equal to the moving force. On the other hand, the vertical component of the moving force is equal to the moving force multiplied by sin 10°, about 17 percent of the moving force.

A moving force is calculated by multiplying a difference in pressure between the inlet port and outlet port of the monolithic rod by the cross-sectional area of the monolithic rod. The outer surface of the tapered monolithic rod undergoes 17 percent of the moving force. That is, it is regarded that the compression stress applied to the cross-sectional area of the monolithic rod is dispersively applied to the area of the outer surface of the tapered monolithic rod.

In the case of this embodiment, 17 percent of the moving force is undergone by the area of the outer surface, which is 530 mm² increased from 4.2 mm² of the cross-sectional area, dispersing and reducing the compression stress to less than one hundredth. The degree of the dispersion of the compression stress depends on a ratio of the areas. Therefore, a sharing rate of the moving force to the vertical component is optimized by adjusting an angle of the slope of the tapered surface in actuality.

A monolithic rod in a tapered shape makes the linear velocity gradually increase from the inlet port toward the outlet port.

However, the influence is negligible because only the height equivalent to a theoretical plate changes a little in the axial direction. Making an analogy, if columns having different numbers of theoretical plates are connected in series, difference of the separation performances of columns does not matter as a whole.

FIG. 4 shows a separation column in accordance with another embodiment of the present invention. It is generally difficult to process an empty column (clad) into a tapered shape over the whole length. In this embodiment, a separation column has a tapered shape only in the vicinity of the inlet port, resulting in an easier processing.

The monolithic rod can be built into an empty column (clad) and can be formed in an empty column (clad). In the latter case, a monolithic rod is formed in a glass tube or a quartz tube, which is a clad, by using a sol-gel method. TEOS (Tetraethoxysilane), for example, is used as a starting compound in the sol-gel method. A polymer, such as HPAA (polyacrylic acid) or PEG (PolyethyleneGlycol), is used as a phase-separation agent.

In the above embodiments, the monolithic rod has a tapered shape growing in diameter toward the inlet port of the separation column in which a mobile phase flows. The monolithic rod can have a tapered shape growing in diameter toward the outlet port of the separation column.

The monolithic rod in the tapered shape growing in diameter toward the outlet port reduces a force applied to the tip of the monolithic rod (the end surface of the outlet port) and makes it hard to destroy the tip.

When the clad, which undergoes the tip of the monolithic rod, is rigid, the monolithic rod is not misaligned and firmly retained even if a strong pressure from the mobile phase is applied to the monolithic rod. As a result, a tight contact is continued by the tapered surface between the monolithic rod and the clad; a gap is not generated by the misalignment of the monolithic rod; and hence a high-pressure delivery of the mobile phase can be continued.

Main features of the above embodiments are listed below.

1. A separation column including a porous monolithic rod formed in a tapered-columnar shape.

2. A separation column including a clad having a tapered bore in the interior.

3. A separation column according to the above item 1, wherein the monolithic rod has a diameter of 1.2 to 2.8 mm at the center of the taper and a length of 30 to 200 mm.

4. A separation column according to the above item 1, wherein the monolithic rod is located along the central axis of the separation column.

5. A separation column according to the above item 1, wherein a mobile phase flows into the separation column with a pressure of 5 to 60 MPa.

6. A separation column according to the above item 1, wherein a mobile phase flows into the separation column with a flow rate of 0.5 to 2.0 mL/min.

7. Separation columns including plural connected separation columns according to the above item 1.

8. A liquid chromatograph including a separation column according to any one of the above items 1 to 6.

9. A separation column wherein the interface between a monolithic rod and a clad is inclined toward the central axis of the separation column.

What is claimed is:

1. A separation column comprising:
a monolithic rod being made of a porous material and allowing a sample and a mobile phase to flow into; and
a clad containing the monolithic rod;
wherein the monolithic rod has a tapered-columnar shape.

2. A separation column comprising:
a monolithic rod being made of a porous material and allowing a sample and a mobile phase to flow into; and
a clad containing the monolithic rod;
wherein the clad has a tapered bore in an interior.

3. A separation column comprising:
a monolithic rod extending in a direction of an axis of the separation column, being made of a porous material and allowing a sample and a mobile phase to flow into; and
a clad containing the monolithic rod;
wherein an interface between the monolithic rod and the clad is inclined toward the axis of the separation column.

4. The separation column according to claim 1,
wherein the monolithic rod has a length of 30 to 200 mm and a diameter at a center is 1.2 to 2.8 mm.

5. The separation column according to claim 1,
wherein the monolithic rod is located along a central axis of the clad.

6. The separation column according to claim 1,
wherein the mobile phase flows into the separation column with a pressure of 5 to 60 MPa.

7. The separation column according to claim 1,
wherein the mobile phase flows into the separation column with a flow rate of 0.5 to 2.0 mL/min.

8. The separation column according to claim 1,
wherein the monolithic rod has an inlet port with a diameter larger than a diameter at an outlet port by 0.1 mm or more.

9. The separation column according to claim 1,
wherein the monolithic rod is formed by a sol-gel reaction in the clad having a vacancy in the interior.

10. The separation column according to claim 1,
wherein the plural separation columns are connected in series.

11. A liquid chromatograph comprising the separation column according to claim 1.

12. A separation column comprising:
a monolithic rod being made of a porous material and allowing a sample and a mobile phase to flow into from an inlet port; and
a clad containing the monolithic rod;
wherein a shape of an interface between the monolithic rod and the clad in the vicinity of the inlet port broadens toward an exterior of the inlet port.

13. A separation column comprising:
a monolithic rod being made of a porous material and allowing a sample and a mobile phase to flow into from an inlet port toward an outlet port; and
a clad containing the monolithic rod;
wherein a shape of an interface between the monolithic rod and the clad broadens from the inlet port toward the outlet port.
